(19) United States
(12) Patent Application Publication
(10) Pub. No.: US 2022/0161799 A1
(43) Pub. Date: May 26, 2022

(54) METHOD FOR SELECTING A TRAFFIC LANE OF A ROUNDABOUT, FOR A MOTOR VEHICLE

(71) Applicants: RENAULT S.A.S, BOULOGNE-BILLANCOURT (FR); Nissan Motor Co., Ltd., Yokohama-shi, Kanagawa (JP)

(72) Inventors: Jorge DA SILVA, Saint Denis (FR); Chrysanthi PAPAMICHAIL, Maisons Laffitte (FR)

(21) Appl. No.: 17/437,071

(22) PCT Filed: Mar. 5, 2020
(86) PCT No.: PCT/EP2020/055896

§ 371 Date: Sep. 8, 2021

(30) Foreign Application Priority Data
Mar. 14, 2019 (FR) 1902637

(51) Int. Cl. B60W 30/18; B60W 60/00; B60W 40/04

(52) U.S. Cl. CPC B60W 30/18163; B60W 60/0015; B60W 2420/52; B60W 2552/10; B60W 2554/80; B60W 40/04

(57) ABSTRACT

A method is performed for selecting a traffic lane of a roundabout for a motor vehicle traveling in the roundabout that has a plurality of traffic lanes and a plurality of exits. The method includes detecting the traffic lanes of the roundabout and third party driving on the traffic lanes, determining a first data relating to an occupancy level of the traffic lanes under consideration by third party vehicles, and a second data relative to the number of traffic lanes to be crossed in order to change traffic lanes from a current traffic lane to the lane in question, calculating the value of a cost function for each of the traffic lanes of the portion depending on the first data and the second data, and selecting one of the traffic lanes for the motor vehicle depending on each calculated value of the cost function.

### CROSS-REFERENCE TO RELATED APPLICATIONS

This application is a U.S. national stage application of International Application No. PCT/EP2020/055896, filed on Mar. 5, 2020.

### BACKGROUND

### Technical Field

The present disclosure relates in general to the field of driving assistance for motor vehicles, and in particular for autonomous vehicles. It relates more particularly to a method for selecting a traffic lane of a roundabout that it is preferable for the motor vehicle to take.

### Background Information

When a motor vehicle enters a roundabout, it is common for this vehicle to take the traffic lane located furthest to the outside of the roundabout when it has to exit quickly (when driving on at most one quarter of the roundabout), and otherwise for it take a traffic lane located further to the inside of the roundabout.

It is then sought to automate this selection of a traffic lane in the context of programming a processing unit of an autonomous vehicle.

To this end, document U.S. Patent Application Publication No. 2007/0150182 discloses a navigation system for guiding a driver or an autonomous vehicle on a roundabout in order to reach an exit that is optimum with respect to a desired destination. In particular, the navigation system is designed to determine the traffic lane that makes it possible to reach this exit in the most efficient manner possible.

In that document, the processing unit is designed to determine, based on geolocation data, the number of traffic lanes on the roundabout, the number of traffic lanes at the entrance lane to the roundabout and the presence or absence of a traffic light at the entrance to the roundabout.

The processing unit, based on these data, then generates a command for the driver or for the autonomous navigation system of the vehicle relating to the optimum traffic lane to be taken to reach the desired exit.

### SUMMARY

It has been discovered that a major drawback of the system disclosed in the above mentioned U.S. patent application publication is that it does not make it possible on its own to ensure the completely safe crossing of the roundabout for the motor vehicle.

In order to rectify the abovementioned drawback from the prior art, the present invention proposes a method for selecting a traffic lane of a roundabout that takes into account the presence of other vehicles on the roundabout, and therefore potential risks of collision with these other vehicles.

More particularly, what is proposed according to the invention is a method for selecting a traffic lane of a roundabout comprising a number L of traffic lanes (where L≥1). The method comprises steps of:
detecting the traffic lanes of the roundabout and other vehicles driving on the traffic lanes,
determining, for each traffic lane under consideration from among at least some of the detected traffic lanes, a first item of data relating to the occupancy of the traffic lane under consideration i (where 1≤i≤L) by the other vehicles, and a second item of data relating to the number of traffic lanes to be crossed in the event of changing traffic lane from a current traffic lane j (where 1≤j≤L) to the traffic lane under consideration,
calculating the value of a cost function for each traffic lane under consideration, based on the first item of data and of the second item of data, and
selecting one of the traffic lanes under consideration based on each calculated value of the cost function.

Thus, by virtue of the invention, the choice of the traffic lane to be taken on the roundabout depends not only on the desired exit but also on the occupancy of the lanes of the roundabout by other vehicles and on a risk of collision with these other vehicles in the event of changing traffic lane. It therefore allows safe driving of the motor vehicle when crossing the roundabout.

Other advantageous and nonlimiting features of the method according to the invention, taken on their own or in any technically possible combination, are as follows:
after the selection step, provision is made for a step of determining the possibility or the risk for the motor vehicle to change traffic lane in order to move toward the selected traffic lane;
given a traffic lane adjacent to the current traffic lane being taken by the motor vehicle, in the step of determining the possibility or the risk for the motor vehicle to change traffic lane, it is checked that a maneuvering time necessary for the motor vehicle to change lane in order to reach a desired location from the adjacent traffic lane is strictly less than the arrival time necessary for another vehicle traveling on the adjacent traffic lane to arrive at the desired location;
with the motor vehicle being equipped with a geolocation means, there is provision for steps of determining a desired exit from among a plurality of exits of the roundabout, a step of detecting, based on the geolocated position of the motor vehicle, a current exit that, from among the plurality of exits of the roundabout, is the one closest to the motor vehicle, and then the selection step is performed based on the position of the current exit with respect to the desired exit;
the selection step is implemented iteratively when the motor vehicle is traveling on the roundabout;
with the motor vehicle being equipped with a geolocation means, the selection step is implemented each time the motor vehicle is located at an exit of the roundabout;
there is provision for a step of determining a number of times the motor vehicle passes a desired exit of the roundabout, the selection step being performed based on the determined number of passes; and
with the motor vehicle being equipped with at least one telemetry sensor, with the first item of data comprising an occupancy level of each traffic lane under consideration by the other vehicles, the occupancy level is obtained based on the measurements performed by the telemetry sensor.

Of course, the various features, variants and embodiments of the invention may be combined with one another in various combinations, provided that they are not incompatible or mutually exclusive.

### BRIEF DESCRIPTION OF THE DRAWINGS

Referring now to the attached drawings which form a part of this original disclosure.

FIG. 1 is a schematic view of a motor vehicle able to implement a selection method according to the present disclosure,

FIG. 2 is a first example of a roundabout in which the selection method may be implemented,

FIG. 3 is a second example of a roundabout in which the selection method may be implemented,

FIG. 4 is a third example of a roundabout in which the selection method may be implemented,

FIG. 5 is a fourth example of a roundabout in which the selection method may be implemented,

FIG. 6 is a fifth example of a roundabout in which the selection method may be implemented,

FIG. 7 is a sixth example of a roundabout in which the selection method may be implemented, and

FIG. 8 shows one example of a method according to the invention in the form of a flowchart.

### DETAILED DESCRIPTION OF EMBODIMENTS

The following description with reference to the appended drawings, which are given by way of nonlimiting example, will give a good understanding as to the content of the invention and how it may be implemented. It will first of all be noted that identical or similar elements appearing in the various Figs. will, as far as possible, be referenced using the same reference signs, and will not be described each time.

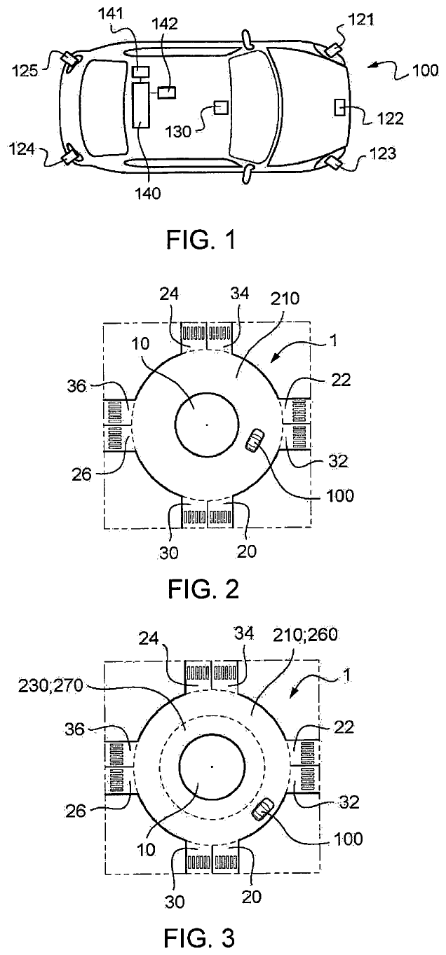

FIG. 1 shows a motor vehicle 100 seen from above.

As is apparent in this Fig., the motor vehicle 100 is in this case a conventional automobile, having a chassis that is supported by wheels and that itself supports various equipment, including a drivetrain, braking means and a steering unit.

It may be a manually driven vehicle, in which case it will be equipped with means for displaying information to the driver or, preferably, an autonomous vehicle. It is also the case of an autonomous vehicle that will be considered here in the remainder of this disclosure.

This motor vehicle 100 is equipped with sensors allowing it to locate itself in its surroundings so as to be able to drive autonomously, that is to say without human intervention.

Any type of sensor may be used.

In the example shown in FIG. 1, the motor vehicle 100 is equipped with a camera 130 oriented ahead of the vehicle in order to capture images of the surroundings located ahead of the vehicle. This camera 130 is for example positioned in an upper central portion of the windscreen in the passenger compartment of the motor vehicle 100.

The motor vehicle 100 is furthermore equipped with at least one telemetry sensor (RADAR, LIDAR or SONAR). More precisely, it is equipped in this case with five RADAR sensors 121, 122, 123, 124, 125 located in the four corners of the vehicle and in a front central position of the vehicle.

The motor vehicle 100 is also equipped with a geolocation system 141, comprising for example a GNSS receiver (typically a GPS sensor).

In order to process the information provided by these various components and to be able to develop a control instruction for the drivetrain, the braking means and the steering unit, the motor vehicle 100 is equipped with a computer 140.

This computer 140 comprises a processor (CPU), an internal memory, analog-to-digital converters, and various input and/or output interfaces.

By virtue of its input interfaces, the computer 140 is able to receive input signals from the various sensors.

The computer 140 is moreover connected to an external memory 142 that stores a road map. It will be considered here that this is a detailed map in which the features of roundabouts (geometry and/or number of traffic lanes, number of entrances and exits, positions of these entrances and exits) are provided.

The internal memory of the computer 140 for its part stores a computer application, consisting of computer programs comprising instructions which, when executed by the processor, allow the computer to implement the method described below.

Lastly, by virtue of its output interfaces, the computer 140 is able to transmit instructions to the various units of the vehicle.

FIGS. 2 to 7 show various types of roundabouts 1 seen from above.

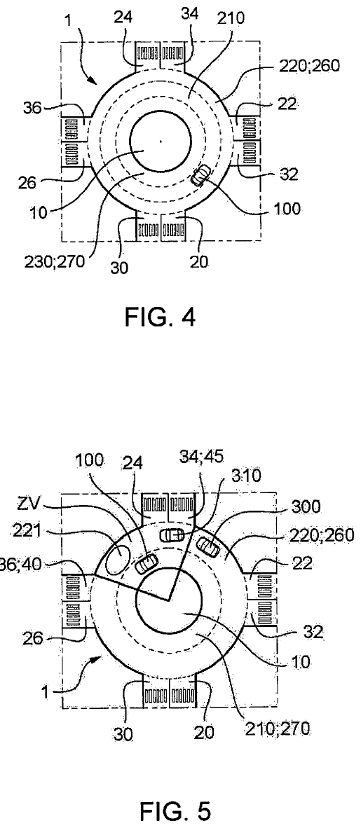

These various roundabouts 1 have a specific number L (where L≥1) of traffic lanes 210, 220, 230 on which motor vehicles are able to travel. In the remainder of this description, consideration will be given to roundabouts 1 with one traffic lane 210 as in FIG. 2, roundabouts 1 with two traffic lanes as in FIGS. 3, 5 and 6, and roundabouts with more than two traffic lanes, such as for example with three traffic lanes (FIGS. 4 and 7).

As may be seen in the Figs., the roundabout 1 in this case has a central island 10 around which the vehicles are able to turn in order to travel on the roundabout.

The roundabouts also have a plurality of entrances 20, 22, 24, 26 and exits 30, 32, 34 and 36.

It will be considered here that each roundabout has four entrances and four exits that are distributed in a cross shape. Of course, as a variant, the configuration of the roundabout could be different.

In the remainder of this disclosure, a distinction will be drawn between:
the current traffic lane 210 taken by the motor vehicle 100 under consideration,
the adjacent traffic lanes 220, 230 (if the roundabout has a number of traffic lanes greater than or equal to two), while distinguishing between the adjacent traffic lanes 220 that are adjacent to the right of the current traffic lane 210 and the adjacent traffic lanes 230 that are adjacent to the left of the current traffic lane 210.

For the remainder of this disclosure, it is also possible to introduce the outermost traffic lane 260 of the roundabout (that the vehicle will take in particular to exit the roundabout) and the innermost traffic lane 270 of the roundabout.

As shown in FIGS. 5 to 7, it will be considered here that motor vehicles other than the motor vehicle 100 under consideration, hereinafter called other vehicles 300, 310, 320, 330, are also driving on the traffic lanes of the roundabout.

When the motor vehicle 100 under consideration, which is considered to be autonomous here, enters a roundabout, it has to choose one of the traffic lanes 210, 220, 230 to enter the roundabout in order to move toward the desired exit of the roundabout.

This desired roundabout exit is determined for example by navigation software, taking into account the destination location desired by the passengers of the motor vehicle 100.

The computer 140 therefore has to determine which traffic lane the motor vehicle 100 should take in order to cross the roundabout 1 as quickly as possible and in complete safety to reach the desired exit.

To this end, the computer 140 implements a method comprising a plurality of steps that are described below.

As a variant, the method could be implemented by an infrastructure external to the motor vehicle 100, for example by an infrastructure positioned in the middle of or close to the roundabout.

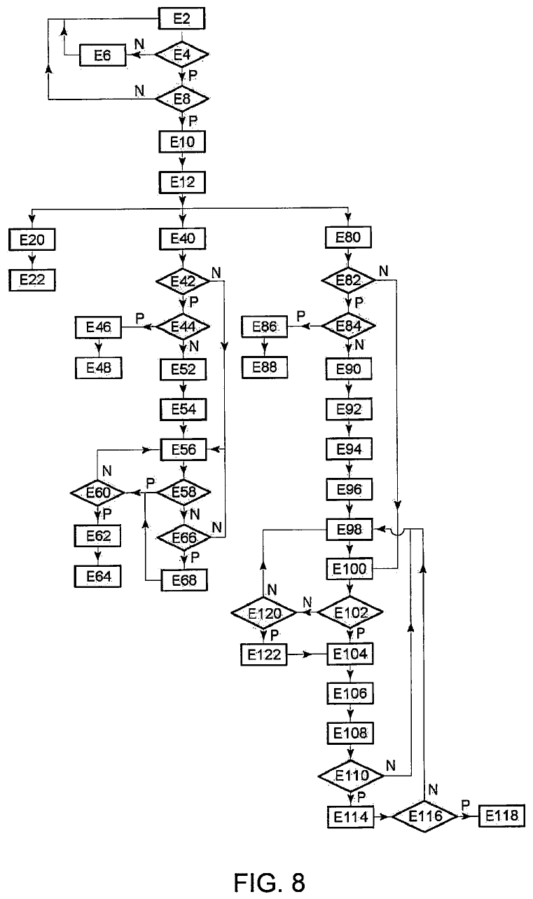

The sequence of steps implemented in the context of this method is shown in FIG. 8 in the form of a flowchart.

Prior to the implementation of the method, it is therefore considered that the motor vehicle 100 is traveling on a road in order to reach a desired destination location. In practice, a sequence of instructions, determined for example from the geolocation system 141, allows the motor vehicle 100 to travel to the desired destination.

It will then be considered in this case that the motor vehicle 100 enters the roundabout 1.

As shown in FIG. 8, the method starts in a step E2 with the real-time acquisition, on the route of the motor vehicle 100, of data measured by the various equipment (RADAR sensors and cameras) of the motor vehicle 100 relating to its surroundings.

The following step E4 consists in checking that these data are able to be used. Specifically, it may turn out, in particular depending on the weather conditions, that this is not the case.

For this check, the computer 140 receives, from each of the items of equipment, a confidence index (expressed here in the form of a confidence percentage for the reliability of the measurement that it performs), which it compares with a predetermined threshold.

If the confidence index is not high enough, the method may not give a driving instruction with regard to the lane to be taken to cross the roundabout. In step E6, the process is then interrupted. This interruption may be expressed in various ways. For example, the means for displaying information for the attention of the driver may indicate to the driver that no driving indication is available on the roundabout. As a variant, the method may also return to step E2 with the acquisition of new data a few meters further along (and therefore a re-evaluation of the situation).

If the confidence index is high enough, the method illustrated in FIG. 8 continues with a step E8.

This step E8 consists in determining the geography of the locations, in particular in order to detect the possible presence of a roundabout 1 on a following part of its route.

To this end, the computer 140 uses either the camera 130 on its own or the geolocation means 141 coupled to the external memory 142, or all of these elements in combination.

More precisely, in this case, it acquires an image captured by the camera 130, and the geolocated position of the motor vehicle 100. Given this geolocated position, the motor vehicle 100 is able to find, in the external memory 142, a map of the region crossed by the motor vehicle 100 in order to locate a possible roundabout.

If no upcoming roundabout is detected, the method returns to step E2 with the acquisition of new data regarding the following part of the route of the motor vehicle 100.

If a roundabout is located on a next part of the route, the computer 140 uses the features regarding the geography of the locations, in particular to determine the number of lanes on the roundabout and the various exits that it comprises (step E10). The computer 140 also locates the desired exit 40 that the motor vehicle 100 should take to reach the desired destination (step 12).

If the roundabout comprises just one traffic lane (as is the case in FIG. 2), the vehicle necessarily has to take this in order to cross the roundabout 1 (step E20). The method therefore leads to the issuance of the command consisting in indicating that the motor vehicle 100 should drive on this single lane (step E22).

If the roundabout has two traffic lanes (FIGS. 3, 5 and 6), the method continues in step E40.

The computer 140 users the geolocated position of the motor vehicle 100 in order to determine whether it will enter or has already entered the roundabout (step E42).

If the motor vehicle 100 is entering the roundabout, the method continues with step E44. If not, it continues with step E56.

In step E44, the computer 140 determines the position of the entrance via which the motor vehicle 100 will enter the roundabout with respect to the desired exit 40. In other words, the computer 140 determines whether the desired exit 40 corresponds to the next exit of the roundabout or whether it is further away. For the examples in FIGS. 3, 5 and 6, if the motor vehicle 100 enters the roundabout via the entrance 20, the computer 140 determines whether the desired exit 40 is the next exit (exit 32) or one of the other exits (exits 34, 36 or 30).

If the desired exit 40 is the next exit, the computer 140 indicates, in step E46, the command to follow, consisting in taking the outermost traffic lane 260 of the roundabout in order to move toward the desired exit 40 as quickly as possible. In step E48, the motor vehicle 100 exits the roundabout via the desired exit 40, in this case exit 32.

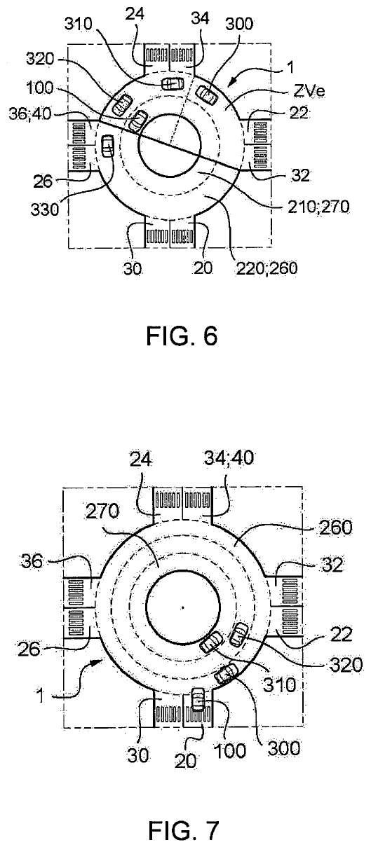

If the desired exit 40 is not the next exit encountered by the motor vehicle 100 on the roundabout (case shown in FIGS. 5 and 6), the computer 140 indicates, in step E52, the instruction consisting in taking the innermost traffic lane 270 of the roundabout. The motor vehicle 100 therefore enters the roundabout by situating itself on this inner traffic lane 270.

However, it checks beforehand that it is able to situate itself fully safely on this inner traffic lane 270. To this end, it performs what will be described below in step E60.

The motor vehicle 100 then drives on this inner traffic lane 270 (step E54).

The geolocated position of the motor vehicle 100 is updated continuously while the motor vehicle is traveling. In particular, the computer 140 regularly determines, from this updated geolocated position, the exit of the roundabout at which the motor vehicle 100 is located with respect to the desired exit 40 (step E56). In practice, this determination is performed iteratively. For example, each time the motor vehicle 100 is located at a roundabout exit (called “current exit 45” hereinafter), the computer 140 determines whether the desired exit 40 is the following exit of the roundabout or another exit. As a variant, the desired exit 40 is located at (predetermined) regular time intervals.

From this updated geolocated position, the computer 140 determines, in step E58, whether the next exit is the desired exit 40.

If this is the case, the computer 140 then indicates that the motor vehicle 100 should move toward the outer traffic lane 260 in order to get closer to the desired exit 40. In practice, as shown in FIG. 5, a traffic lane change region ZV is then defined between the current exit 45 (before the desired exit 40) and the desired exit 40.

The computer 140 therefore determines, in step E60, whether it is possible for the motor vehicle 100 to change traffic lane (therefore to move toward the outer traffic lane 260) without a risk in this region ZV.

To this end, the computer 140 calculates the maneuvering time t_{EGO} that will be necessary for the motor vehicle 100 to reach the outer traffic lane 260 (that it wishes to take in order to reach the desired exit 40) and the location at which this vehicle will arrive after this lane change. For example, the computer 140 locates a location 221 of the outer traffic lane 260 that the motor vehicle 100 will reach if it changes lane (see FIG. 5).

Then, if another vehicle already traveling on this outer traffic lane 260 is present, the computer 140 calculates the arrival time t_{OBJ} that will be necessary for this other vehicle to reach this location 221. In the example in FIG. 5, the computer 140 determines the time that the other vehicle 310 will take to reach the location 221.

According to the invention, the maneuvering time t_{EGO} and the arrival time t_{OBJ} are determined by the computer 140 based for example on the execution of an algorithm based in particular on the data measured by the various equipment (RADAR sensors and cameras) and on kinematic predictions (for example regarding the route) derived by the computer 140 based on the desired destination.

The criterion for determining whether it is possible for the motor vehicle 100 to change traffic lane then consists in satisfying the following inequality:

t_{EGO}<min(_{OBJ})+δt,

where δt is a predetermined safety margin stored in the internal memory of the computer 140. As a variant, this safety margin may for example depend on the instantaneous speed of the motor vehicle 100, on the weather conditions or on the category of the motor vehicle 100 (truck, light vehicle).

If this inequality is satisfied (the case in FIG. 5), there is no risk in changing traffic lane, and the motor vehicle 100 moves toward the outer traffic lane 260 (step E62). When it reaches the desired exit 40, the motor vehicle 100 exits the roundabout by taking this desired exit 40 (step E64).

If this inequality is not satisfied (this meaning that there would be a risk in changing lane as shown in FIG. 6 with the other vehicle 330 being present), the motor vehicle 100 remains in its traffic lane 210, in this case the inner traffic lane 270 of the roundabout, and the method returns to step E56.

When the computer detects, in step E58, that the next exit is not the desired exit 40, the method continues in step E66. In this step, the computer 140 determines, from the various geolocated positions of the motor vehicle 100 (that are stored in the external memory 142), the number of times that the motor vehicle 100 has been located at the desired exit 40 without however being able to take it in order to exit the roundabout. In other words, the computer 140 determines the number of trips around the roundabout that the motor vehicle 100 has already had to take without being able to exit it safely.

If this is the first trip around the roundabout taken by the motor vehicle 100, the motor vehicle continues on its traffic lane (in this case the inner traffic lane 270) and the method returns to step E56.

If the vehicle has already taken a number k of trips around the roundabout greater than or equal to 1, the method continues in step E68. In practice, if the motor vehicle 100 has not been able to move toward the desired exit 40 in one (or more) previous trip(s) around the roundabout, the computer 140 attempts to anticipate the lane change so that the motor vehicle 100 is able to reach the desired exit 40 as quickly as possible (therefore avoiding one or more further additional trips around the roundabout). This results in a more extensive traffic lane change region ZVe being defined.

Thus, in step E68, if the motor vehicle 100 has already taken k trips around the roundabout, the lane change region will extend starting from the (k+1)th exit before the desired exit 40 (more precisely between the (k+1)th exit before the desired exit 40 and the desired exit 40). If k is equal to the number of exits that the roundabout contains, the computer 140 will drive the steering unit of the motor vehicle 100 such that the motor vehicle 100 immediately changes from the current traffic lane 210 to the desired traffic lane, in this case the outer traffic lane 260.

For example, if the motor vehicle 100 has already taken one trip around the roundabout (k=1), the lane change region will extend between the penultimate exit before the desired exit 40 and the desired exit 40. This extended lane change region ZVe is shown for example in FIG. 6.

The method then continues in step E60 in order to check that the motor vehicle 100 is effectively able to change traffic lane without any risk (there is no provision for the motor vehicle 100 to change traffic lane without a new preliminary check).

As shown in FIG. 8, if, in step E42, the computer 140 determines, from the geolocated position, that the motor vehicle 100 is already on a roundabout, the method continues directly in step E56. Steps E56 to E68 then take place in the manner described above.

A description may now be given of the case in which the roundabout has more than two traffic lanes, for example three lanes here, as shown in FIGS. 4 and 7. In this case, the method continues in step E80 (step corresponding to identifying a roundabout with more than two traffic lanes).

The computer 140 uses the geolocated position of the motor vehicle 100 in order to determine whether this will enter or has already entered the roundabout (step E82).

Steps E82 to E88 are identical, respectively, to steps E42 to E48 introduced above, and are not described again here.

If, in step E82, the computer 140 determines that the desired exit 40 is not the next exit encountered by the motor vehicle 100 on the roundabout, the computer 140 determines, in step E90, the traffic lane on which the motor vehicle 100 will be able to enter (so as then to cross the roundabout).

To this end, in step E90, the computer 140 evaluates the occupancy level of the various traffic lanes of the roundabout (except for the outer traffic lane 260 that is used only for the motor vehicle 100 to exit the roundabout). The computer 140 uses the data measured by the various equipment of the motor vehicle 100 (in particular RADAR sensors and cameras) by combining them with for example a data fusion algorithm such as a Kalman filter.

In particular, based on the measured data, the computer 140 identifies the various other vehicles traveling on the roundabout. From this identification, the computer 140 determines a first item of data pᵢ relating to the occupancy of the traffic lane i under consideration (where 1≤i≤L) by the other vehicles traveling thereon. In practice, this first item of data pᵢ corresponds to the occupancy percentage pᵢ of each traffic lane i.

This occupancy percentage pᵢ is calculated using the following formula:

pᵢ=Sᵥₑₕ/Sᵢ, where Sᵥₑₕ is the surface area occupied by other vehicles on the traffic lane i and Sᵢ is the total surface area of the lane.

In practice, each other vehicle is modeled by a rectangle defined based on four points forming this rectangle. The area of each rectangle (and therefore the corresponding other vehicle) is assigned to the traffic lane that comprises these four points forming this rectangle.

If the four points belong to the same lane, the entire surface area of the corresponding other vehicle contributes to the calculation of the occupancy percentage of the traffic lane i under consideration.

If another vehicle is straddling two traffic lanes, the surface area of the associated rectangle then has two portions, determined considering the line separating the lanes as a polynomial. Each of these two portions of the surface area of the rectangle is then associated respectively with a traffic lane.

In step E92, the computer 140 determines an identification criterion for the entrance lane to the roundabout 1 by attempting to minimize the occupancy percentage pi calculated for each traffic lane i under consideration of the roundabout from among the innermost traffic lanes of the roundabout 1.

In step E94, the computer 140 then determines the least busy inner traffic lane, that is to say the one corresponding to the lowest occupancy percentage pᵢ.

At the end of step E94, the computer 140 has identified the traffic lane that the motor vehicle 100 should take to enter the roundabout in complete safety. The motor vehicle 100 therefore moves toward this traffic lane in step E96.

The motor vehicle 100 then drives in this selected traffic lane (step E98).

The geolocated position of the motor vehicle 100 is updated continuously during the travel of the motor vehicle. As introduced above, the computer 140 regularly determines, based on this updated geolocated position, the exit of the roundabout at which the motor vehicle 100 is located with respect to the desired exit 40 (in this case in step E100, which is similar to step E56 described above).

Based on the updated geolocated position, the computer 140 determines, in step E102, whether the next exit is the desired exit 40.

If this is the case, the computer 140 determines (step E104), for the traffic lanes furthest outside the current traffic lane, the first item of data in accordance with the method explained in step E90.

In this step E104, the computer 140 also determines a second item of data R_{j->i} relating to artificial preference of the outermost traffic lanes so as to make it easier to select these outermost lanes (in order to make it easier for the motor vehicle 100 to exit the roundabout 1). This second item of data R_{j->i} corresponds to an item of weighting data linked to the occupancy level of each target traffic lane i able to be selected so as to make it easier for the motor vehicle 100 to exit the roundabout 1 (which motor vehicle is currently on the current traffic lane j, where 1≤j≤L). This second item of data R_{j->i} therefore makes it possible not to give preference to travel of the motor vehicle 100 toward a busy traffic lane (in order to avoid the motor vehicle 100 remaining stuck on the roundabout 1). In other words, this second item of data R_{j->i} is determined so as to give preference to travel of the motor vehicle 100 toward the traffic lanes outside the current traffic lane j (and in particular toward the outer traffic lane 260) in order to make it easier for it to exit the roundabout 1. In practice, the second item of data R_{j->i} relates to the number of traffic lanes to be crossed in order to reach the target traffic lane i.

This second item of data is expressed here using the following formula:

$${R}_{j \to i} = {\sum }_{j = 1}^{n ( i )} \frac{1}{n ( j ) - 1} , n ( j ) \neq 1 \qquad Math . 1$$

where n(j) is a number associated with the current traffic lane j (by definition, for the outermost traffic lane, n(j)=1, and for the innermost traffic lane, n(j)=L, L being the number of traffic lanes on the roundabout), and

n(i) is the number associated with a target traffic lane i (in this case the one under test).

In practice, the second item of data R_{j->i} will be smaller for the outer traffic lane 260 and increasingly higher for increasingly inner traffic lanes. For example, the second item of data R_{j->i} will be higher for the travel of the motor vehicle between the inner traffic lane 230 and the central traffic lane than for the travel of the motor vehicle between the inner traffic lane 230 and the outer traffic lane 260 (in order to give preference to travel of the motor vehicle 100 toward the outer traffic lane so that it is able to exit the roundabout 1 without remaining stuck there).

The computer 140 then uses these two items of data in step E106 in order to calculate a cost function J_{j->i} associated with each traffic lane i. This cost function evaluates the cost to move from the current traffic lane j of the motor vehicle 100 to the target traffic lane i. The cost function is for example determined experimentally.

This cost function is expressed here using the following formula:

$${J}_{j \to i} = 1 - \frac{{T}_{L , i} + {R}_{j \to 1}}{2} \qquad Math . 2$$

where T_{L,i} is a parameter relating to the average traffic level between the current traffic lane j of the motor vehicle 100 and the target traffic lane i, calculated from the occupancy percentage p_{I} of each traffic lane I, I being defined so as to satisfy the inequality i≤I≤j, T_{L,i} being defined as the sum of the occupancy percentages p_{I}, where i ≤I≤j, and R_{j->i} is the second item of data as defined above.

At the end of step E106, the cost functions J_{j->i} for each of the traffic lanes i accessible to the motor vehicle 100 are calculated. The computer 140 determines the traffic lane associated with the greatest cost function J_{j->i} (step E108). In other words, the computer 140 identifies the traffic lane to be taken by the motor vehicle 100 by maximizing the cost function J_{j->i}.

Thus, by maximizing the cost function, the computer 140 determines the best traffic lane that the motor vehicle 100 should take in order to move toward the desired exit 40 (step E108). It should be noted at this juncture that the traffic lane selected by maximizing the cost function is not necessarily the outermost traffic lane of the roundabout. It corresponds to the traffic lane furthest outward from the current traffic lane that the motor vehicle 100 is able to reach in full safety.

However, before moving there, the computer 140 determines whether it is possible for the motor vehicle 100 to change traffic lane (therefore to move toward the traffic lane selected from the maximization of the cost function in step E108).

To this end, the computer 140 calculates, in step E110, the maneuvering time t_{EGO} in accordance with the definition introduced above.

If the safety criterion characterized by the inequality t_{EGO}<min(t_{OBJ})+δt is not satisfied (this meaning that there would be a risk in changing lane), the motor vehicle 100 remains in its traffic lane 210, and the method returns to step E98.

If the safety criterion is satisfied, there is no risk in changing traffic lane, and the motor vehicle 100 moves toward the selected traffic lane (step E114).

However, it is not certain at this stage that the selected traffic lane is the outer traffic lane of the roundabout, and that therefore allows the motor vehicle to take the desired exit 40. Based on the geolocation data, the computer 140 therefore determines whether the selected traffic lane is the outer traffic lane of the roundabout (step E116).

If this is the case, when it reaches the desired exit 40, the motor vehicle 100 leaves the roundabout by taking this desired exit 40 (step E118).

By contrast, if the selected traffic lane is not the outer traffic lane, the motor vehicle 100 continues on its current traffic lane and the method returns to step E98.

When the computer 140 detects, in step E 102, that the next exit is not the desired exit 40, the method continues in step E120. In this step, similar to step E66 described above, the computer 140 determines, based on the various geolocated positions of the motor vehicle 100 (which are stored in the memory 142), the number of times that the motor vehicle 100 has been located at the desired exit 40 without however being able to take it in order to leave the roundabout. In other words, the computer 140 determines the number of trips around the roundabout that the motor vehicle 100 has already had to take without being able to exit, it safely.

If this is the first trip around the roundabout taken by the motor vehicle 100, the motor vehicle continues on its traffic lane and the method returns to step E98.

If the vehicle has already taken a number k of trips around the roundabout, the method continues in step E122, in which the computer 140 will attempt to anticipate the lane change so that the motor vehicle 100 is able to reach the desired exit 40 as quickly as possible (therefore avoiding one or more further trips around the roundabout). This step is similar to step E68 described above.

The method then continues in step E104 with the determination of a traffic lane furthest outward from the current lane, with the calculation of the cost function (there is no provision to change traffic lane without selecting the best traffic lane toward which the motor vehicle 100 will be able to move in complete safety).

The present invention is in no way limited to the embodiment described and shown, but a person skilled in the art will know how to add any variant according to the invention thereto.

In particular, the way in which the vehicle is guided so as to cross a roundabout comprising three traffic lanes may be applied in order to guide the vehicle when crossing a roundabout comprising two traffic lanes.

1. A method for selecting a traffic lane of a roundabout for a motor vehicle traveling in the roundabout that has a plurality of traffic lanes, the method comprising:
detecting the traffic lanes of the roundabout and other vehicles driving on the traffic lanes,
determining, for each of the traffic lanes under consideration from among at least some of the traffic lanes that were detected, a first data relating to an occupancy level of each of the traffic lanes under consideration by the other vehicles, and a second data relating to a number of the traffic lanes to be crossed in order to change traffic lanes from a current traffic lane to one of the traffic lanes under consideration,
calculating a value of a cost function for each of the traffic lanes under consideration, based on the first data and the second data, and
selecting one of the traffic lanes under consideration as the selected traffic lane based on each of the values of the cost function that were calculated.

2. The selection method as claimed in claim 1, comprising:
determining a possibility or a risk for the motor vehicle to change traffic lane in order to move toward the selected traffic lane after selecting the selected traffic lane.

3. The selection method as claimed in claim 2, wherein
the step of the determining of the possibility or the risk for the motor vehicle to change traffic lane includes checking a maneuvering time necessary for the motor vehicle to change lane in order to reach a desired location from the other traffic lane is strictly less than an arrival time necessary for another vehicle traveling on the other traffic lane to arrive at the desired location.

4. The selection method as claimed in claim 1, further comprising:
determining a desired exit from among a plurality of exits of the roundabout, and
detecting a current exit that is the one closest to the motor vehicle from among the plurality of exits of the roundabout based on a geolocated position of the motor vehicle, and
the selection of the selected traffic lane being performed based on a position of the current exit with respect to a desired exit.

5. The selection method as claimed in claim 1, wherein
the selection of the selected traffic lane is implemented iteratively when the motor vehicle is traveling on the roundabout.

6. The selection method as claimed in claim 1, wherein
the, selection of the selected traffic lane is implemented each time the motor vehicle is located at an exit of the roundabout.

7. The selection method as claimed in claim 1, further comprising, wherein
determining a number of times the motor vehicle passes a desired exit of the roundabout, and the selection of the selected traffic lane being performed based on the number of times the motor vehicle passes the desired exit of the roundabout.

8. The selection method as claimed in claim 1, wherein
the occupancy level of each of the traffic lanes is obtained based on measurements performed by telemetry sensor of the motor vehicle.
